(19) United States
(12) Patent Application Publication
(10) Pub. No.: US 2025/0349869 A1
(43) Pub. Date: Nov. 13, 2025

(54) METHOD FOR OPERATING A FUEL CELL SYSTEM, AND A CONTROL DEVICE

(71) Applicant: Robert Bosch GmbH, Stuttgart (DE)

(72) Inventor: Helerson Kemmer, Vaihingen (DE)

(21) Appl. No.: 18/868,950

(22) PCT Filed: May 24, 2023
(86) PCT No.: PCT/EP2023/063927

§ 371 Date: Nov. 25, 2024

(30) Foreign Application Priority Data
Jun. 1, 2022 (DE) 10 2022 205 567.5

(51) Int. Cl. H01M 8/04303; H01M 8/04228; H01M 8/04746; H01M 8/04828; H01M 8/04955

(52) U.S. Cl. CPC H01M 8/04303; H01M 8/04228; H01M 8/04761; H01M 8/04843; H01M 8/04955

(57) ABSTRACT

The invention relates to a method for operating a fuel cell system (1) having multiple fuel cell stacks (100, 200), which each have a cathode (110, 210) and an anode (120, 220), air being supplied to the cathodes (110, 210) via at least one supply air path (111, 211), and exhaust air emitted from the fuel cell stacks (100, 200) being discharged via at least one exhaust air path (112, 212), and the anodes (120, 220) each being supplied with hydrogen via an anode circuit (121, 221). According to the invention, when the fuel cell system (1) is switched off, the exhaust air from a first fuel cell stack (100) is introduced into the anode circuit (221) of a further fuel cell stack (200). Using the introduced exhaust air, the anode (220) of the further fuel cell stack (200) is rendered inert in a first phase of the switch-off process and is dried in a second phase of the switch-off process.

The invention also relates to a control device for a fuel cell system (1) for carrying out steps of a method according to the invention.

### BACKGROUND

The invention relates to a method for operating a fuel cell system. The invention also relates to a control device for a fuel cell system for carrying out steps of the method.

Preferred areas of application are fuel cell vehicles, preferably fuel cell vehicles with start-stop operation.

Fuel cells are electrochemical energy converters. In particular, hydrogen (H₂) and oxygen (O₂) can be used as reaction gases. These are converted into electrical energy, water (H₂O), and heat with the aid of a fuel cell. The core of a fuel cell is a membrane electrode assembly (MEA), which comprises a membrane coated on both sides with a catalytic material to form electrodes. During operation of the fuel cell, one electrode, the anode, is supplied with hydrogen and the other electrode, the cathode, is supplied with oxygen.

In practice, a large number of fuel cells are connected to form a fuel cell stack in order to increase the electrical output. In addition, multiple fuel cell stacks or fuel cell systems can be interconnected to form so-called multi-stack systems.

During operation of a fuel cell system, start and/or stop phases represent a high load that can lead to degradation of the fuel cells. At the start, the main cause of this is a hydrogen-air front in the anode. When stopping or shutting down, it is a high voltage that is present due to the fact that the anode is supplied with hydrogen and the cathode with oxygen without an electrical load being drawn from the stack. This can occur in particular during long shutdown phases.

In order to counteract the degradation of the fuel cells in a start and/or stop phase, the oxygen present in the cathode can be consumed before the system is shut down by drawing electrical current without additional air supply. Meanwhile, the anode continues to be supplied with hydrogen so that the cell voltages are not critical. However, if air diffuses into the cathode, the cell voltages increase and remain there for several hours, causing damaging electrochemical reactions. As a rule, shut-off valves are therefore provided on both the inlet and outlet sides to prevent air from entering the cathode in the event of a shutdown. However, as these are not completely sealed, especially over their service life, their effectiveness is limited. Furthermore, the shut-off valves are associated with a not insignificant pressure loss.

From stationary applications, it is known that the anode is rendering inert with nitrogen before shutdown to counteract unwanted degradation. The nitrogen is stored in a bottle for this purpose. However, this is not possible in mobile applications for reasons of space. Furthermore, a nitrogen cylinder has to be refilled and maintained, which has a negative impact on costs.

In an earlier application by the same applicant, it was therefore already proposed for multi-stack systems to use the exhaust air emerging from a fuel cell stack to render inert the anode of another fuel cell stack. However, as the exhaust air exiting a fuel cell stack is moist, the liquid water and/or condensate it contains can cause water to accumulate, blocking the gas supply when restarting and thus leading to a local undersupply of hydrogen. Accumulations of water can also freeze at ambient temperatures below 0° C. and lead to icing, which makes restarting impossible.

The present invention is concerned with the task of counteracting the degradation of fuel cells when a multi-stack fuel cell system is shut down, without the aforementioned problems occurring.

In order to solve this problem, the method according to the disclosure is proposed. Advantageous embodiments can be found in the sub-claims. In addition, a control device for a fuel cell system for carrying out steps of the method is disclosed.

### SUMMARY

A method is proposed for operating a fuel cell system having multiple fuel cell stacks, which each have a cathode and an anode, air being supplied to the cathodes via at least one supply air path, and exhaust air emitted from the fuel cell stacks being discharged via at least one exhaust air path, and the anodes each being supplied with hydrogen via an anode circuit. According to the invention, when the fuel cell system is switched off, the exhaust air from a first fuel cell stack is introduced into the anode circuit of a further fuel cell stack and, using the introduced exhaust air, the anode of the further fuel cell stack is rendered inert in a first phase of the switch-off process and is dried in a second phase of the switch-off process.

The switch-off process therefore comprises at least two phases, a first phase for inertization and a second phase for drying. As inertization is followed by drying, the largely oxygen-free but moist exhaust air from a first fuel cell stack can be used to render inert the anode of another fuel cell stack. This is because the subsequent drying process removes the moisture. This means that the risk of the harmful water accumulation mentioned at the beginning is significantly reduced.

Because the exhaust air from a first fuel cell stack is used to render inert the anode of another fuel cell stack, no additional inert gas, such as nitrogen, needs to be kept available, so there is no need to carry and refill at least one gas cylinder.

In the proposed process, the first fuel cell stack is preferably operated in depletion operation in the first phase of the switch-off process. In depletion operation, the fuel cell stack is operated sub-stoichiometrically, i.e. with λₐᵢᵣ<1, so that the oxygen content of the exhaust air leaving the fuel cell stack is reduced to a minimum. Accordingly, depletion operation supports the production of inert gas, which can then be used to render inert the anode of the next fuel cell stack.

Furthermore, in the first phase, the air supply to the further fuel cell stack is interrupted by switching off an air conveying and air compression system integrated in the supply air path and/or by closing at least one valve, in particular a shut-off valve. This measure ensures that no further oxygen is supplied to the cathode of the fuel cell stack to be rendered inert.

As a further measure, it is proposed that, in the first phase, a pressure controller integrated into the anode circuit of the further fuel cell stack is closed. This means that the hydrogen supply to the anode circuit is interrupted so that it can be filled with the exhaust air from the first fuel cell stack.

Furthermore, in the first phase, a shut-off valve arranged in a connecting line is opened for introducing the exhaust air from the first fuel cell stack into the anode circuit of the further fuel cell stack. Only when the shut-off valve is opened does exhaust air flow from the exhaust air path of the first fuel cell stack into the anode circuit of the other fuel cell stack. The shut-off valve is preferably only opened after the hydrogen supply to the anode circuit has been interrupted, so that it is ensured that only exhaust air or inert gas enters the anode circuit.

Furthermore, it is proposed that, in the first phase, a purge valve and/or drain valve integrated in the anode circuit of the further fuel cell stack is opened. Any anode gas still present in the anode can be displaced via the open purge valve and/or drain valve when the exhaust air is introduced, so that the anode circuit fills with exhaust air or inert gas.

During the transition from the first to the second phase, the depletion operation of the first fuel cell stack is ended and normal operation is started. This is because the oxygen content of the gas used for drying is irrelevant for drying the anode in the second phase.

Preferably, in the second phase, a bypass path bypassing the first fuel cell stack is opened by opening a bypass valve. This means that air, not exhaust air, is supplied to the rest of the fuel cell stack, as the bypass path connects the supply air path with the exhaust air path. Air and not inert gas is therefore used to dry the anode in the second phase of the switch-off process. If the air is compressed beforehand using an air conveying and air compression system integrated into the supply air path, the air is heated up considerably beforehand, so that the water absorption capacity increases.

In the second phase of the switch-off process, the cathode of the other fuel cell stack can be dried in addition to the anode. The cathode can be dried independently of the anode. This is because the air supply that was interrupted in the first phase is preferably restored to dry the cathode of the other fuel cell stack, so that the cathode is supplied with air again via the supply air path. This means that the cathode's “own” air is used to dry it.

To restore the air supply to the cathode, the air conveying and air compression systems that were previously switched off in the first phase are switched on again and/or the previously closed valve, in particular the shut-off valve, is opened again. Opening the shut-off valve requires the presence of such a valve, as a non-return valve can also be provided instead of a shut-off valve. Since a valve, either a shut-off valve or a non-return valve, is usually provided in both the supply air path and the exhaust air path, at least two valves are opened in the case of shut-off valves.

As soon as the anode of the further fuel cell stack has dried, the connection of the exhaust air path of the first fuel cell stack to the anode circuit of the further fuel cell stack can be interrupted again in the second phase. This means that the shut-off valve previously opened in the first phase, which is located in the connecting line linking the exhaust air path to the anode circuit, is closed again.

As soon as the cathode of the other fuel cell stack has dried, the air supply to the cathode of the other fuel cell stack can be interrupted again in the second phase. This means that the air conveying and air compression system is switched off. If shut-off valves are provided in the supply air path and in the exhaust air path, these are closed.

Once the anode and cathode have dried, the switch-off process is complete and the fuel cell system can be shut down completely.

In addition, a control device for a fuel cell system is proposed, which is configured to carry out steps of a method according to the invention. The method can thus be automated. Furthermore, a smooth transition from inertization in the first phase to drying in the second phase of the switch-off process can be created.

### BRIEF DESCRIPTION OF THE DRAWINGS

A preferred embodiment of the invention is explained in more detail below with reference to the accompanying drawings. Shown are:

FIG. 1 a schematic illustration of a multi-stack fuel cell system that can be operated according to the method of the invention,

FIG. 2 the sequence of a process according to the invention,

FIG. 3 a schematic illustration of the fuel cell system of FIG. 1 showing the direction of flow of the exhaust air in the first phase and

FIG. 4 a schematic illustration of the fuel cell system of FIG. 1, showing the direction of air flow in the second phase of the switch-off process.

### DETAILED DESCRIPTION

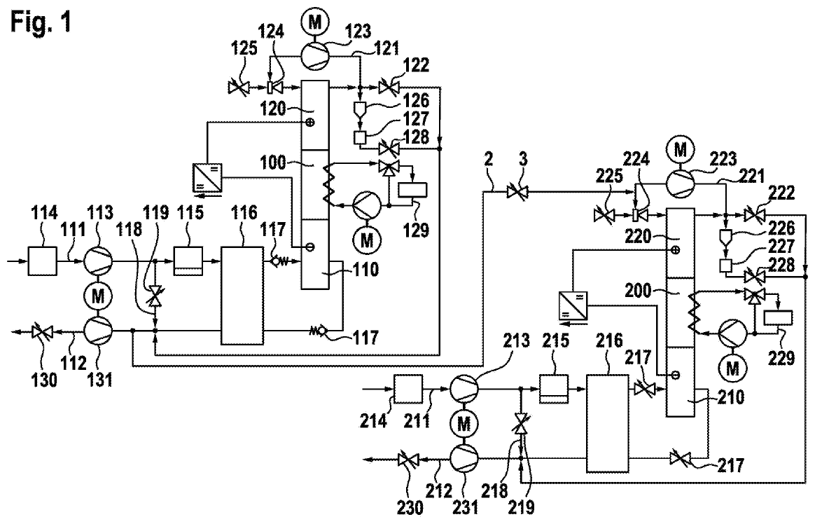

FIG. 1 shows a fuel cell system 1 according to the invention with a first fuel cell stack 100 and a second fuel cell stack 200.

The first fuel cell stack 100 has a cathode 110 and an anode 120. The cathode 110 is supplied with air as an oxygen supplier via a supply air path 111. The air is taken from the environment and fed via an air filter 114 to an air conveying and air compression system 113 in order to provide a certain air mass flow and a certain pressure level. As the air heats up, it is cooled with the aid of a heat exchanger 115 integrated into the feed air path 111 and humidified further downstream with the aid of a humidifier 116. The air then enters the cathode 110 of the fuel cell stack 100 via a first valve 117, which is designed as a non-return valve in the present case.

The exhaust air from the fuel cell stack 100 is discharged via an exhaust air path 112, in which a further valve 117 is arranged in the form of a non-return valve. Downstream of the valve 117, the humidifier 116 is integrated into the exhaust air path 112 so that the humid exhaust air can be used to humidify the feed air. Downstream of the humidifier 116, the exhaust air is fed to a turbine 131 followed by a pressure regulator 130. With the aid of the turbine, some of the energy used for compression can be recovered, since the air conveying and air compression system 113 can be driven by means of the turbine 131. To bypass the fuel cell stack 100, the feed air path 111 and the exhaust air path 112 can be connected via a bypass path 118 with integrated bypass valve 119.

The anode 120 is supplied with fresh anode gas or hydrogen and recirculated anode gas via an anode circuit 121. Recirculation is achieved passively with the aid of a jet pump 124 and actively with the aid of a fan 123. Since the recirculated anode gas is enriched with nitrogen over time, which diffuses from the cathode side to the anode side, a purge valve 122 is provided in the anode circuit 121. By opening the purge valve 122, anode gas containing nitrogen is discharged from the anode circuit 121 and replaced by fresh anode gas via an open hydrogen metering valve (not shown). Since the recirculated anode gas is also enriched with water, a water separator 126 with a container 127 is integrated into the anode circuit 121. The container 127 can be emptied from time to time by opening a drain valve 128.

The heat generated during operation of the fuel cell stack 100 is discharged with the aid of a cooling circuit 129.

The exhaust air path 112 of the fuel cell stack 100 is connected to an anode circuit 221 of the further fuel cell stack 200 via a connecting line 2 with integrated shut-off valve 3. When the shut-off valve 3 is open, exhaust air from the first fuel cell stack 100 can thus be introduced into the anode circuit 221 of the other fuel cell stack 200. Anode gas enriched with exhaust air then enters an anode 220 of the further fuel cell stack 200 via the anode circuit 221.

For the sake of simplicity, the two fuel cell stacks 100 and 200 are largely identical. However, this is not a prerequisite for being able to carry out the method according to the invention. Identical components are indicated with the same reference numerals, whereby the components of the first fuel cell stack 100 are each preceded by a “1” and the components of the second fuel cell stack 200 are each preceded by a “2”. With regard to the description of the components of the further fuel cell stack 200, reference is made to the description of the components of the first fuel cell stack 100. In contrast to the first fuel cell stack 100, the valves 217 of the second fuel cell stack 200 are not designed as non-return valves, but as controllable shut-off valves.

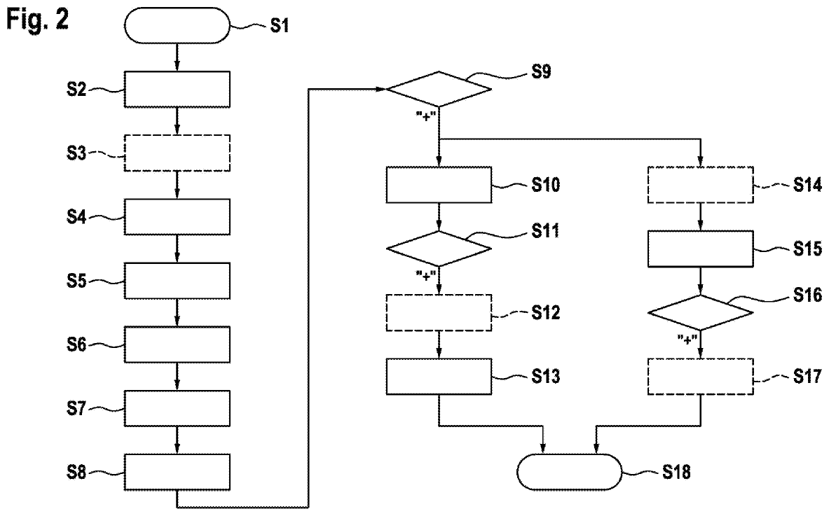

The fuel cell system 1 shown in FIG. 1 can be operated according to the method described below and shown in FIG. 2 in the event of shutdown.

The process shown in FIG. 2 comprises two phases. A first phase for rendering inert an anode 220 and a second phase for drying the anode 220 and a cathode 210.

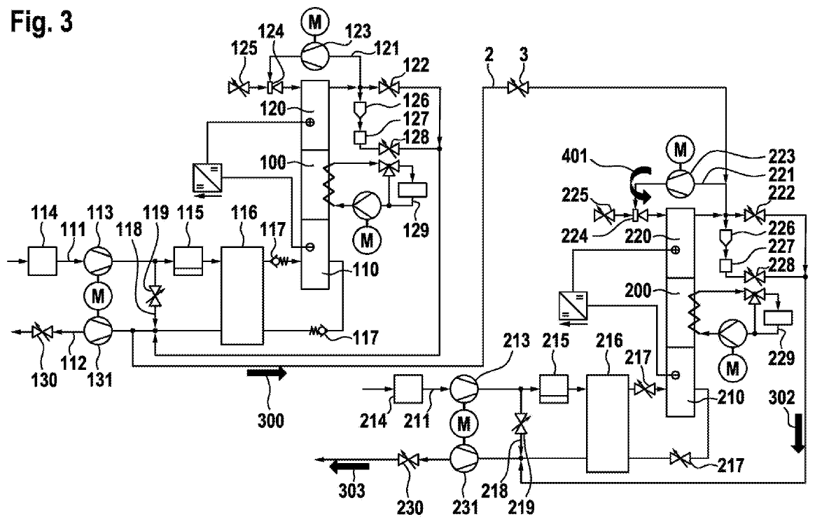

The first phase comprises steps S1 to S8, which are described below with reference to FIG. 2 in conjunction with FIG. 3.

In step S1, the inertization of the anode 220 of the further fuel cell stack 200 is started using the exhaust air from the first fuel cell stack 100. For this purpose, the air supply to the fuel cell stack 200 is first interrupted in step S2, i.e. the air conveying and air compression system 213 is switched off. In addition, the valves 217 are closed in step S3, which is possible in the present case as these are designed as controllable shut-off valves. If no shut-off valves but non-return valves are provided, step S3 is omitted. In step S4, oxygen depletion of the cathode 210 of the fuel cell stack 200 then follows. Subsequently, in step S5, the first fuel cell stack 100 is only operated in depletion operation, so that λₐᵢᵣ<1. The first fuel cell stack 100 thus produces largely oxygen-free exhaust air or inert gas, which can be used to render inert the anode 220 of the other fuel cell stack 200.

In step S6, an anode-side pressure controller 225 of the further fuel cell system 200 is then closed, so that the hydrogen supply is interrupted. Then, in step S7, the shut-off valve 3 in the connecting line 2 is opened so that the exhaust air from the first fuel cell stack 100 enters the anode circuit 221 of the other fuel cell stack 200 (see FIG. 3, arrows 300 and 301). In order to remove the anode gas still present in the anode circuit 221, the purge valve 222 and/or the drain valve 228 is/are opened. The anode circuit 221 fills with exhaust air or inert gas and is rendered inert in this way. The excess exhaust air is discharged via the open purge valve 222 and/or the open drain valve 228 via a connecting line 232 into the exhaust air path 212 of the further fuel cell system 200 (see FIG. 3, arrows 320 and 303).

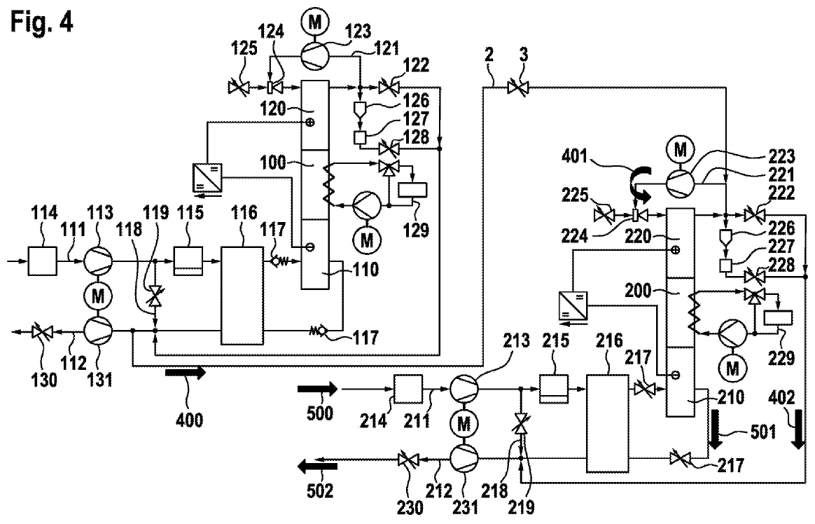

In step S9, it is checked whether the anode 221 is inert. If yes (“+”), you can move on to the second phase. This comprises steps S10 to S13 and serves to dry the anode 221 of the further fuel cell system 200. In parallel, the cathode 210 can be dried in the second phase. Steps S14 to S17 are carried out for this purpose. The steps in the second phase of the switch-off process are described below with reference to FIG. 2 in conjunction with FIG. 4.

In step S10, the depletion operation of the first fuel cell stack 100 is ended and normal operation is resumed, so that λₐᵢᵣ>1. Additionally, the bypass valve 119 is opened so that the air from the supply air path 111 flows into the exhaust air path 112 via the bypass path 118. The other fuel cell stack 200 is therefore mainly supplied with air and no exhaust air via the connecting line 2 (see FIG. 4, arrow 400). The air passes through the connecting line 2 into the anode circuit 221 and from there into the anode 220 to dry it (see FIG. 4, arrow 401). The moist air escaping from the anode 220 is discharged via the open purge valve 222 and/or the open drain valve 228 (see FIG. 4, arrow 402).

Step S11 checks whether the anode 220 is dry. If yes (“+”), the shut-off valve 3 in the connection line 2 and the purge valve 222 and/or the drain valve 228, if open, are closed again in step S12. Subsequently, in step S13, the air mass flow via the bypass path 118 can be interrupted again or at least reduced by closing the bypass valve 119 of the first fuel cell stack 100.

Steps S14 to S17 for drying the cathode 210 can be carried out in parallel. For this purpose, the valves 217 previously closed in the first phase are opened again in step S14. In step S15, the air conveying and air compression system 213 is switched on again, so that the air supply to the cathode 210 is no longer interrupted (see FIG. 4, arrow 500). The air mass flow generated using the air conveying and air compression system 213 finally leads to the drying of the cathode 210. The moist air emerging from the cathode 210 is discharged via the exhaust air path 212 (see FIG. 4, arrows 501 and 502).

Step S16 checks whether the cathode 210 is dry. If yes (“+”), the air supply to the cathode 210 can be interrupted again in step S17. For this purpose, the air conveying and air compression system 213 is switched off. The valves 217 are also closed.

The switch-off process ends in step S18.

1. A method for operating a fuel cell system (1) having multiple fuel cell stacks (100, 200), which each have a cathode (110, 210) and an anode (120, 220), air being supplied to the cathodes (110, 210) via at least one supply air path (111, 211), and exhaust air emitted from the fuel cell stacks (100, 200) being discharged via at least one exhaust air path (112, 212), and the anodes (120, 220) each being supplied with hydrogen via an anode circuit (121, 221),
wherein when the fuel cell system (1) is switched off, the exhaust air from a first fuel cell stack (100) is introduced into the anode circuit (221) of a further fuel cell stack (200) and, using the introduced exhaust air, the anode (220) of the further fuel cell stack (200) is rendered inert in a first phase of the switch-off process and is dried in a second phase of the switch-off process.

2. The method according to claim 1,
wherein the first fuel cell stack (100) is operated in depletion operation in the first phase.

3. The method according to claim 1,
wherein, in the first phase, the air supply to the further fuel cell stack (200) is interrupted by switching off an air conveying and air compression system (213) integrated in the supply air path (211) and/or by closing a shut-off valve.

4. The method according to claim 1,
wherein, in the first phase, a pressure controller (225) integrated into the anode circuit (221) of the further fuel cell stack (200) is closed.

5. The method according to claim 1,
wherein, in the first phase, a shut-off valve (3) arranged in a connecting line (2) is opened for introducing the exhaust air from the first fuel cell stack (100) into the anode circuit (221) of the further fuel cell stack (200).

6. The method according to claim 1,
wherein, in the first phase, a purge valve (222) and/or drain valve (228) integrated in the anode circuit (221) of the further fuel cell stack (200) is opened.

7. The method according to claim 1,
wherein, in the transition from the first to the second phase, the depletion operation of the first fuel cell stack (100) is ended and normal operation is started.

8. The method according to claim 1,
wherein, in the second phase, a bypass path (118) bypassing the first fuel cell stack (100) is opened by opening a bypass valve (119).

9. The method according to claim 1,
wherein, in the second phase, in addition to the anode (220), the cathode (210) of the further fuel cell stack (200) is dried.

10. The method according to claim 10,
wherein the air supply interrupted in the first phase is restored to dry the cathode (210) of the further fuel cell stack (200).

11. The method according to claim 1,
wherein, in the second phase, the connection of the exhaust air path (112) of the first fuel cell stack (100) to the anode circuit (221) of the further fuel cell stack (200) is interrupted as soon as the anode (220) of the further fuel cell stack (200) has dried.

12. The method according to claim 1,
wherein, in the second phase, the air supply to the cathode (210) of the further fuel cell stack (200) is interrupted again as soon as the cathode (210) has dried.

13. A control device for a fuel cell system (1), which is configured to carry out steps of a method according to claim 1.
